(19) United States
(12) Patent Application Publication
(10) Pub. No.: US 2026/0246141 A1
(43) Pub. Date: Aug. 20, 2026

(54) RADIO COMMUNICATION APPARATUS AND MEASUREMENT SYSTEM WITH RADIO COMMUNICATION FUNCTION

(71) Applicant: Mitsubishi Electric Corporation, Chiyoda-ku, Tokyo (JP)

(72) Inventors: Hiroaki SAKAMOTO, Tokyo (JP); Hidetoshi MAKIMURA, Tokyo (JP); Koji HIGUCHI, Tokyo (JP); Kengo NISHIMOTO, Tokyo (JP)

(21) Appl. No.: 19/160,698

(22) PCT Filed: Mar. 29, 2023
(86) PCT No.: PCT/JP2023/012901

§ 371 Date: Aug. 28, 2025

(51) Int. Cl. H01Q 1/52; H01Q 1/22; H01Q 1/38

(52) U.S. Cl. CPC H01Q 1/521; H01Q 1/22; H01Q 1/38

(57) ABSTRACT

A radio communication apparatus includes a substantially square ground conductor disposed on a substantially square dielectric substrate, and a first antenna, a second antenna, and a third antenna disposed on the dielectric substrate. The first antenna is disposed along a first side of the dielectric substrate, the second antenna is disposed along a second side adjacent to the first side of the dielectric substrate, and the third antenna is disposed along a third side facing the first side of the dielectric substrate. An open end of the first antenna is directed in a direction away from the second side, an open end of the second antenna is directed in a direction away from the first side, and an open end of the third antenna is directed in a direction away from the second side.

### TECHNICAL FIELD

The present disclosure relates to a radio communication apparatus, and particularly to antenna equipment.

### BACKGROUND ART

When radio communication is performed under a multipath environment, it is effective to provide radio communication apparatuses with diversity functions to avoid deterioration of communication quality by multipath fading. The radio communication apparatuses with the diversity functions seek to increase gains of each of antennas by using a plurality of the antennas and lower correlations between the antennas. The correlations between the antennas increase as radiation patterns of the antennas are more similar. Furthermore, reducing amounts of coupling between the antennas is equivalent to lowering the correlations between the antennas.

In a diversity antenna including two or more antennas, a method of lowering a correlation between the antennas is being studied. For example, a radio communication apparatus disclosed in Patent Document 1 can receive radio waves in a frequency band (473 MHz to 767 MHz) of television broadcasting, includes total four antennas along three sides of a substrate, and increases isolation between the antennas and suppress a decrease in the gains of the antennas by disposing the antennas orthogonal to each other or shortening electrical distances between the antennas. Furthermore, a radio communication apparatus disclosed in Patent Document 2 can simultaneously and smoothly communicate in different radio communication methods (for example, the Wi-Fi (registered trademark), the Bluetooth (registered trademark), and the ZigBee (registered trademark)) in the same frequency band, includes total four antennas of two 920 MHz band antennas and two 2.4 GHz band antennas along three sides of a substrate, and suppresses interferences between the antennas by disposing the antennas at the same frequency orthogonal to each other at diagonal positions of the substrate.

### PRIOR ART DOCUMENT

### Patent Document

[Patent Document 1] WO2013/114840
[Patent Document 2] WO2018/043207

### SUMMARY

### Problem to be Solved by the Invention

The correlation between the antennas can be lowered using the technologies of Patent Documents 1 and 2. Simply disposing the antennas orthogonal to each other, however, cannot sufficiently reduce the coupling. Moreover, as the sizes of the radio communication apparatuses continue to shrink, shortening electrical distances between antennas will be difficult. Particularly, as the sizes of substrates become smaller with respect to wavelengths of radio communication signals, the correlation between the antennas increases. Thus, there is apprehension that the communication quality may decrease.

The present disclosure has been conceived to solve the aforementioned problems, and has an object of providing a radio communication apparatus that can lower correlations between a plurality of antennas and increases efficiency of the antennas.

### Means to Solve the Problem

A radio communication apparatus according to the present disclosure includes: a dielectric substrate that is substantially square; a ground conductor disposed on the dielectric substrate, the ground conductor being substantially square; a first antenna disposed on the dielectric substrate along a first side of the dielectric substrate; a second antenna disposed on the dielectric substrate along a second side adjacent to the first side of the dielectric substrate; a third antenna disposed on the dielectric substrate along a third side facing the first side of the dielectric substrate; a first feeding point disposed between the ground conductor and the first antenna, the first feeding point powering the first antenna; a second feeding point disposed between the ground conductor and the second antenna, the second feeding point powering the second antenna; and a third feeding point disposed between the ground conductor and the third antenna, the third feeding point powering the third antenna, wherein an open end of the first antenna is directed in a direction away from the second side, an open end of the second antenna is directed in a direction away from the first side, and an open end of the third antenna is directed in a direction away from the second side.

### Effects of the Invention

The present disclosure lowers correlations between a plurality of antennas, increases efficiency of the antennas, and obtains high communication quality.

The object, features, aspects, and advantages of this disclosure will become more apparent from the following detailed description and the accompanying drawings.

### BRIEF DESCRIPTION OF DRAWINGS

FIG. 1 is a diagram illustrating a structure of a radio communication apparatus according to Embodiment 1.

FIG. 2 is a diagram illustrating, when an arrangement of antennas is changed, results of calculation of changes in correlation between the antennas through electromagnetic simulations.

FIG. 3 is a diagram illustrating a modification of the radio communication apparatus according to Embodiment 1.

FIG. 4 is a diagram illustrating a structure of a radio communication apparatus according to Embodiment 2.

FIG. 5 is a diagram illustrating a circuit structure of the radio communication apparatus according to Embodiment 2.

FIG. 6 is a diagram illustrating Modification 1 of the radio communication apparatus according to Embodiment 2.

FIG. 7 is a diagram illustrating Modification 2 of the radio communication apparatus according to Embodiment 2.

FIG. 8 is a diagram illustrating Modification 3 of the radio communication apparatus according to Embodiment 2.

FIG. 9 is a diagram illustrating a structure of a radio communication apparatus according to Embodiment 3.

FIG. 10 is a diagram illustrating an example decoupling circuit according to Embodiment 3.

FIG. 11 is a diagram illustrating an example decoupling circuit according to Embodiment 3.

FIG. 12 is a diagram illustrating a structure of a radio communication apparatus according to Embodiment 4.

FIG. 13 is a diagram illustrating an example structure of a measurement system according to Embodiment 5.

### DESCRIPTION OF EMBODIMENTS

Embodiments of a technology according to the present disclosure will be described with reference to the drawings. While an example transmission antenna will be mainly described in Embodiments below, obviously, a reception antenna can produce the same advantages due to reversibility of an antenna.

### Embodiment 1

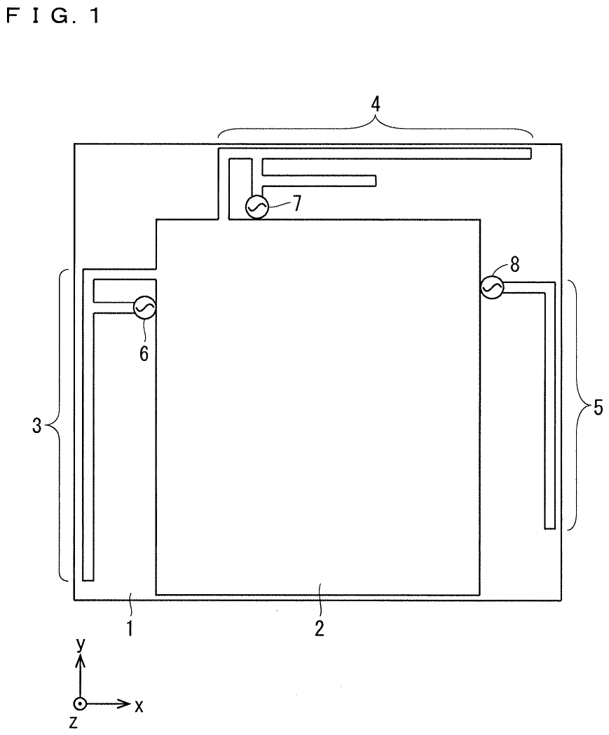

FIG. 1 is a diagram illustrating a structure of a radio communication apparatus according to Embodiment 1. This radio communication apparatus functions as a transmission antenna or a reception antenna.

As illustrated in FIG. 1, the radio communication apparatus according to Embodiment 1 includes a dielectric substrate 1, a ground conductor 2, a first antenna 3, a second antenna 4, a third antenna 5, a feeding point 6 of the first antenna 3, a feeding point 7 of the second antenna 4, and a feeding point 8 of the third antenna 5.

The dielectric substrate 1 is substantially square in a plan view. The ground conductor 2 which is also substantially square is disposed on the dielectric substrate 1. While the dielectric substrate 1 and the ground conductor 2 form a printed circuit board, the ground conductor 2 is handled as a conductor placed on one side of the dielectric substrate 1 for simplifying the description herein. The first antenna 3, the second antenna 4, and the third antenna 5 may be formed on each of sides of the dielectric substrate 1. It is assumed that example materials of the dielectric substrate 1 include glass epoxy.

The first antenna 3, the second antenna 4, and the third antenna 5 are conductor patterns formed on the dielectric substrate 1. While each of the first antenna 3, the second antenna 4, and the third antenna 5 is formed by etching a metal film deposited on the dielectric substrate 1 in Embodiment 1, they may be formed using, for example, a sheet metal or a metal wire.

The feeding point 6 of the first antenna 3 is disposed between the first antenna 3 and the ground conductor 2. The feeding point 7 of the second antenna 4 is disposed between the second antenna 4 and the ground conductor 2. The feeding point 8 of the third antenna 5 is disposed between the third antenna 5 and the ground conductor 2. Each of the feeding points 6, 7, and 8 has a function of driving a high frequency signal.

On the plane of the paper in FIG. 1, the x-axis is taken in a horizontal direction, the y-axis is taken in a vertical direction, the z-axis is taken in a depth direction, the right direction is defined as +x direction, the left direction is defined as −x direction, the upper direction is defined as +y direction, and the lower direction is defined as −y direction.

The first antenna 3 is disposed along a first side of the dielectric substrate 1. Specifically, the first antenna 3 extends in −x direction from the feeding point 6 and branches into two paths. One of portions of the first antenna 3 branching into the two paths extends in −y direction from a branch point along the first side of the dielectric substrate 1, and the other portion is shorted to the ground conductor 2. This allows the first antenna 3 to function as an inverted-F antenna and easily implement impedance matching. The first antenna 3 need not always include a short circuit portion (a portion to be shorted to the ground conductor 2).

In the description on the first antenna 3, a portion extending in −x direction from a base end connected to the feeding point 6 may be referred to as a “vertical portion”, and a portion extending in −y direction from the branch point may be referred to as a “horizontal portion”.

The second antenna 4 is disposed along a second side adjacent to the first side of the dielectric substrate 1 such that the second antenna 4 is orthogonal to the first antenna 3. Specifically, the second antenna 4 extends in +y direction from the feeding point 7 and branches into two paths at a first branch point. One of portions of the second antenna 4 branching at the first branch point extends in +x direction along the second side of the dielectric substrate 1, and the other portion further extends in +y direction. The portion of the second antenna 4 extending in +y direction from the first branch point further branches into two paths at a second branch point. One of portions of the second antenna 4 branching at the second branch point extends in +x direction along the second side of the dielectric substrate 1, and the other portion is shorted to the ground conductor 2. This allows the second antenna 4 to operate as an inverted-F antenna for supporting multiple bands and easily implement impedance matching. The second antenna 4 need not always include a short circuit portion.

In the description on the second antenna 4, a portion extending in +y direction from a base end connected to the feeding point 7 may be referred to as a “vertical portion”, and a portion extending in +x direction from the first branch point or the second branch point may be referred to as a “horizontal portion”.

The third antenna 5 is disposed along a third side facing the first side of the dielectric substrate 1. Specifically, the third antenna 5 extends in +x direction from the feeding point 8, is bent at some midpoint, and extends in −y direction from the bend point along the third side of the dielectric substrate 1. This allows the third antenna 5 to operate as an inverted-L antenna. The third antenna 5 may include a short circuit portion, similarly to the first antenna 3 and the second antenna 4.

In the description on the third antenna 5, a portion extending in +x direction from a base end connected to the feeding point 8 may be referred to as a “vertical portion”, and a portion extending in −y direction from the bend point may be referred to as a “horizontal portion”.

The second antenna 4 is allowed to support multiple bands to correspond to an operating frequency of the first antenna 3 and an operating frequency of the third antenna 5. In other words, assuming that f₁ denotes the operating frequency of the first antenna 3 and f₂ denotes the operating frequency of the third antenna 5, operating frequencies of the second antenna 4 are f₁ and f₂.

The first antenna 3 has an overall length equal to a length of ¼ of a wavelength corresponding to the operating frequency f₁ of the first antenna 3. In other words, a length of the first antenna 3 from the base end of the vertical portion to an end (an open end) of the horizontal portion through the branch point is the length of ¼ of the wavelength corresponding to the operating frequency f₁.

The second antenna 4 has an overall length equal to a length of ¼ of a wavelength corresponding to each of the two operating frequencies f₁ and f₂ of the second antenna 4. In other words, in the second antenna 4, one of a length extending from the base end of the vertical portion to an end (an open end) of the horizontal portion extending from the first branch point and a length extending from the base end of the vertical portion to an end (open end) of the horizontal portion extending from the second branch point is the length of ¼ of the wavelength corresponding to the operating frequency f₁, and the other is a length of ¼ of the wavelength corresponding to the operating frequency f₂.

An overall length of the third antenna 5 is equal to a length of ¼ of a wavelength corresponding to the operating frequency f₂ of the third antenna 5. In other words, a length of the third antenna 5 from a base end of the vertical portion to an end (an open end) of the horizontal portion through the bend point is a length of ¼ of the wavelength corresponding to the operating frequency f₂ of the third antenna 5.

The “length of ¼ of a wavelength” herein does not mean only a value strictly equal to the length of ¼ of the wavelength but includes a range tolerable in positive and negative directions with respect to the length of ¼ of the wavelength.

Furthermore, as seen from FIG. 1, the open end of the first antenna 3 is directed in a direction away from the second side of the dielectric substrate 1 along which the second antenna 4 is disposed. The open end of the second antenna 4 is directed in a direction away from the first side of the dielectric substrate 1 along which the first antenna 3 is disposed. The open end of the third antenna 5 is directed in a direction away from the second side of the dielectric substrate 1 along which the second antenna 4 is disposed.

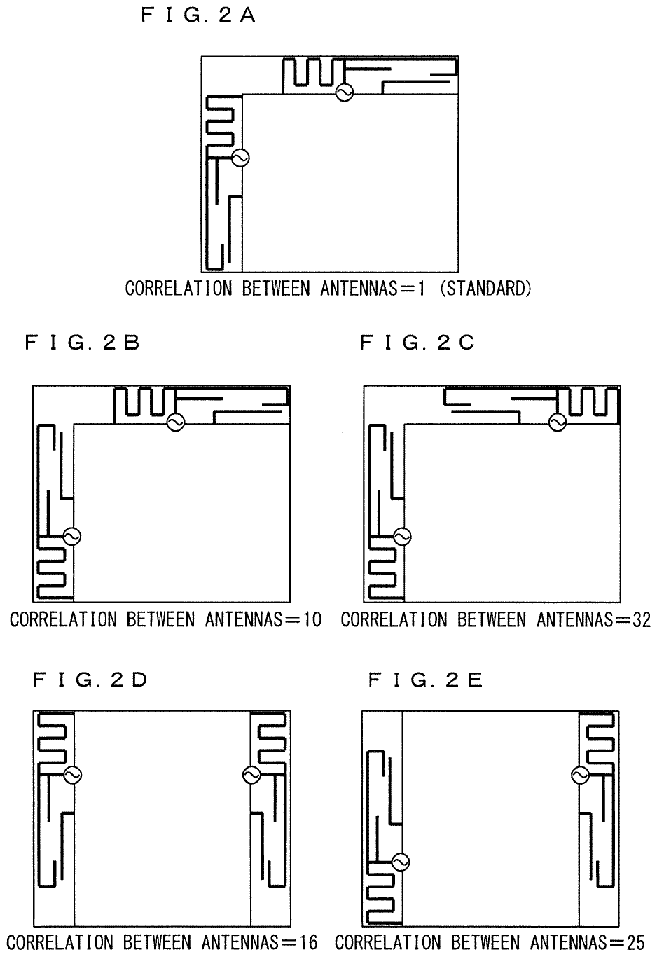

FIG. 2 is a diagram illustrating, when an arrangement (positions and orientations) of two antennas is changed, results of calculation of changes in correlation between the antennas through electromagnetic simulations.

As illustrated in FIG. 2 (a), a correlation between two antennas when the two antennas are disposed orthogonal to each other along adjacent sides of a dielectric substrate, an open end of one of the antennas is directed in a direction away from the side along which the other antenna is disposed, and an open end of the other antenna is directed in a direction away from the side along which the one antenna is disposed is 1, which is used as a standard.

As illustrated in FIG. 2 (b), a correlation between two antennas when the two antennas are disposed orthogonal to each other along adjacent sides of a dielectric substrate, an open end of one of the antennas is directed in a direction approaching the side along which the other antenna is disposed, and an open end of the other antenna is directed in a direction away from the side along which the one antenna is disposed was 10 (i.e., 10 times as high as that in FIG. 2 (a)).

As illustrated in FIG. 2 (c), a correlation between two antennas when the two antennas are disposed orthogonal to each other along adjacent sides of a dielectric substrate, an open end of one of the antennas is directed in a direction approaching the side along which the other antenna is disposed, and an open end of the other antenna is directed in a direction approaching the side along which the one antenna is disposed was 32 (i.e., 32 times as high as that in FIG. 2 (a)).

As illustrated in FIG. 2 (d), a correlation between two antennas when the two antennas are disposed parallel to facing sides of a dielectric substrate and an open end of one of the antennas is directed in the same direction as that of an open end of the other antenna was 16 (i.e., 16 times as high as that in FIG. 2 (a)).

As illustrated in FIG. 2 (e), a correlation between two antennas when the two antennas are disposed parallel to facing sides of a dielectric substrate and an open end of one of the antennas is directed in an opposite direction of that of an open end of the other antenna was 25 (i.e., 25 times as high as that in FIG. 2 (a)).

The results from FIG. 2 (a) to FIG. 2 (c) show that when the two antennas are disposed orthogonal to each other along the adjacent sides of the dielectric substrate, the arrangement of FIG. 2 (a) can suppress the correlation between the antennas the most. Furthermore, the results show that the arrangement of FIG. 2 (b) can suppress the correlation between the antennas lower which is not as much as the arrangement of FIG. 2 (a).

Furthermore, the results from FIG. 2 (d) and FIG. 2 (e) show that when the two antennas are disposed parallel to the facing sides of the dielectric substrate, the arrangement of FIG. 2 (d) can suppress the correlation between the antennas lower than that of the arrangement of FIG. 2 (e).

In the radio communication apparatus according to Embodiment 1, the first antenna 3 and the second antenna 4 are arranged in the arrangement of FIG. 2 (a). This makes the correlation between the first antenna 3 and the second antenna 4 lower, and the first antenna 3 and the second antenna 4 operate as a diversity antenna at the frequency f₁. Furthermore, the second antenna 4 and the third antenna 5 are arranged in the arrangement of FIG. 2 (b). This suppresses the correlation between the second antenna 4 and the third antenna 5 lower, and the second antenna 4 and the third antenna 5 operate as a diversity antenna at the frequency f₂.

As such, the radio communication apparatus can be downsized by allowing the second antenna 4 to support multiple bands. Furthermore, it is possible to provide a diversity function corresponding two radio communication methods at different operating frequencies.

While the operating frequencies f₁ and f₂ may be any frequencies, the operating frequencies f₁ and f₂ preferably satisfy a relationship of f₁<f₂. As seen from FIG. 2 (a) and FIG. 2 (b), the correlation between the first antenna 3 and the second antenna 4 can be easily made lower than the correlation between the second antenna 4 and the third antenna 5 in the radio communication apparatus according to Embodiment 1. Normally, shortening an electrical distance between antennas operating at low frequencies (high wavelengths) is more difficult than shortening an electrical distance between antennas operating at high frequencies (short wavelengths). Thus, it is difficult to make a correlation between the antennas operating at the low frequencies lower than a correlation between the antennas operating at the high frequencies. Thus, making the operating frequency f₂ to be allocated to the second antenna 4 and the third antenna 5 between which lowering the correlation is difficult higher than the operating frequency f₁ to be allocated to the first antenna 3 and the second antenna 4 between which lowering the correlation is easy can easily lower the correlation between the second antenna 4 and the third antenna 5. Thus, both of the correlation between the first antenna 3 and the second antenna 4 and the correlation between the second antenna 4 and the third antenna 5 can be lowered.

While Embodiment 1 describes an example where the first antenna 3 and the second antenna 4 are inverted-F antennas and the third antenna 5 is an inverted-L antenna, shapes of the first antenna 3, the second antenna 4, and the third antenna 5 are not limited to these. The antennas may be, for example, antennas with other shapes, such as meander antennas or folded monopole antennas as long as the effects and the advantages described above are obtained.

Assuming that f₁ denotes the lowest operating frequency supported by a radio communication apparatus and ki denotes a wavelength of the operating frequency f₁, it is assumed that the size of the square dielectric substrate 1 is 0.25λ₁×0.25λ₁. Variations approximately ±0.1λ₁ are tolerable.

Operations of the radio communication apparatus according to Embodiment 1 will be described.

For example, when the first antenna 3 functions as a transmission antenna, a high frequency signal is supplied to the feeding point 6 of the first antenna 3, and the high frequency signal is transmitted to the first antenna 3 through the feeding point 6. Then, a resonance phenomenon occurring when the high frequency signal is traveling through the first antenna 3 causes electromagnetic waves corresponding to the high frequency signal to be radiated from the first antenna 3 to the space. This holds true for the second antenna 4 and the third antenna 5.

Furthermore, when the first antenna 3 functions as a reception antenna, the first antenna 3 receives electromagnetic waves, and outputs a high frequency signal corresponding to the electromagnetic waves received from the feeding point 6 of the first antenna 3. This holds true for the second antenna 4 and the third antenna 5.

The radio communication apparatus according to Embodiment 1 described above can create diversity corresponding to two frequencies (f₁ and f₂) using three antennas with low correlations, and obtains high communication quality.

### [Modifications]

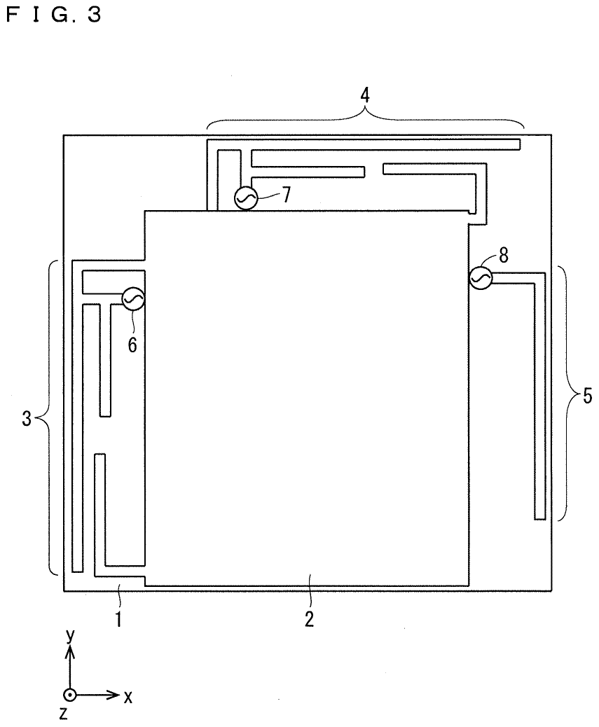

FIG. 3 is a diagram illustrating a modification of the radio communication apparatus according to Embodiment 1. The structure of FIG. 3 is obtained by adding, to the first antenna 3, a parasitic antenna shorted to the ground conductor 2 and an antenna element branching from the first antenna 3, and adding a parasitic antenna shorted to the ground conductor 2 to the second antenna 4 in the structure of FIG. 1.

The radio communication apparatus in FIG. 3 can support not only the operating frequencies f₁ and f₂ but also an operating frequencies f₃. In other words, the first antenna 3 can support not only the operating frequency f₁ but also the operating frequencies f₃, and the second antenna 4 can support not only the operating frequencies f₁ and f₂ but also the operating frequency f₃.

While the operating frequencies f₁, f₂, and f₃ may be any frequencies, the operating frequencies f₁, f₂, and f₃ preferably satisfy a relationship of f₁<f₂<f₃. Since a correlation between antennas tends to increase as the operating frequencies are closer, increasing a difference between the frequencies f₁ and f₃ that are supported by both of the first antenna 3 and the second antenna 4 suppresses the correlation between the first antenna 3 and the second antenna 4.

In this modification, the first antenna 3 has an overall length equal to a length of ¼ of a wavelength corresponding to each of the two operating frequencies f₁ and f₃ of the first antenna 3. In other words, in the first antenna 3, one of a total of a length extending from the base end of the vertical portion to an end of a horizontal portion extending from the first branch point and a length of the parasitic antenna added to the first antenna 3 (a length from a base end of a vertical portion to an end of a horizontal portion through a bend point), and a length extending from the base end of the vertical portion to an end of a horizontal portion extending from the second branch point is the length of ¼ of the wavelength corresponding to the operating frequency f₁, and the other is the length of ¼ of the wavelength corresponding to the operating frequency f₃.

The second antenna 4 has an overall length equal to a length of ¼ of a wavelength corresponding to each of the three operating frequencies f₁, f₂, and f₃ of the second antenna 4. In other words, in the second antenna 4, one of a length extending from the base end of the vertical portion to an end of a horizontal portion extending from the first branch point and a length extending from the base end of the vertical portion to an end of a horizontal portion extending from the second branch point is the length of ¼ of the wavelength corresponding to the operating frequency f₁, and the other is the length of ¼ of the wavelength corresponding to the operating frequency f₂. Then, a length of the parasitic antenna added to the second antenna 4 (a length from a base end of a vertical portion to an end of a horizontal portion through a bend point) is the length of ¼ of the wavelength corresponding to the operating frequency f₃.

Similarly to FIG. 1, the third antenna 5 has an overall length equal to a length of ¼ of a wavelength corresponding to the operating frequency f₂ of the third antenna 5. In other words, a length of the third antenna 5 from a base end of a vertical portion to an end of a horizontal portion through a bend point is the length of ¼ of the wavelength corresponding to the operating frequency f₂ of the third antenna 5.

As seen from FIG. 3, the open end of the first antenna 3 is directed in a direction away from the second side of the dielectric substrate 1 along which the second antenna 4 is disposed in this modification. The open end of the second antenna 4 is directed in a direction away from the first side of the dielectric substrate 1 along which the first antenna 3 is disposed. The open end of the third antenna 5 is directed in a direction away from the second side of the dielectric substrate 1 along which the second antenna 4 is disposed. These make the correlation between the first antenna 3 and the second antenna 4 lower, and the first antenna 3 and the second antenna 4 operate as a diversity antenna at the frequencies f₁ and f₃. These also suppress the correlation between the second antenna 4 and the third antenna 5 lower, and the second antenna 4 and the third antenna 5 operate as a diversity antenna at the frequency f₂.

Although FIG. 3 illustrates an example where the parasitic antenna and the branching antenna element have been added to the first antenna 3, only one of the parasitic antenna and the branching antenna element may be added. Although the parasitic antenna added to the second antenna 4 is connected to a right side of the ground conductor 2 in FIG. 3, the parasitic antenna may be connected to an upper side of the ground conductor 2.

In FIG. 3, the end of the parasitic antenna added to the first antenna 3 is directed in a direction approaching the second side of the dielectric substrate 1 along which the second antenna 4 is disposed, and the end of the parasitic antenna added to the second antenna 4 is directed in a direction approaching the first side of the dielectric substrate 1 along which the first antenna 3 is disposed. This is because the parasitic antenna is coupled to an antenna to be powered.

Opposing the directions of these two parasitic antennas can further make the correlation between the first antenna 3 and the second antenna 4 lower. It should be noted that this may cause a failure in coupling the parasitic antenna to the antenna to be powered. Conversely speaking, as long as coupling between the parasitic antenna and the antenna to be powered can be ensured, the directions of the two parasitic antennas may be opposite to those in FIG. 3.

The radio communication apparatus according to this modification can create diversity corresponding to three frequencies (three of f₁, f₂, and f₃) using three antennas with low correlations, and obtains high communication quality.

### Embodiment 2

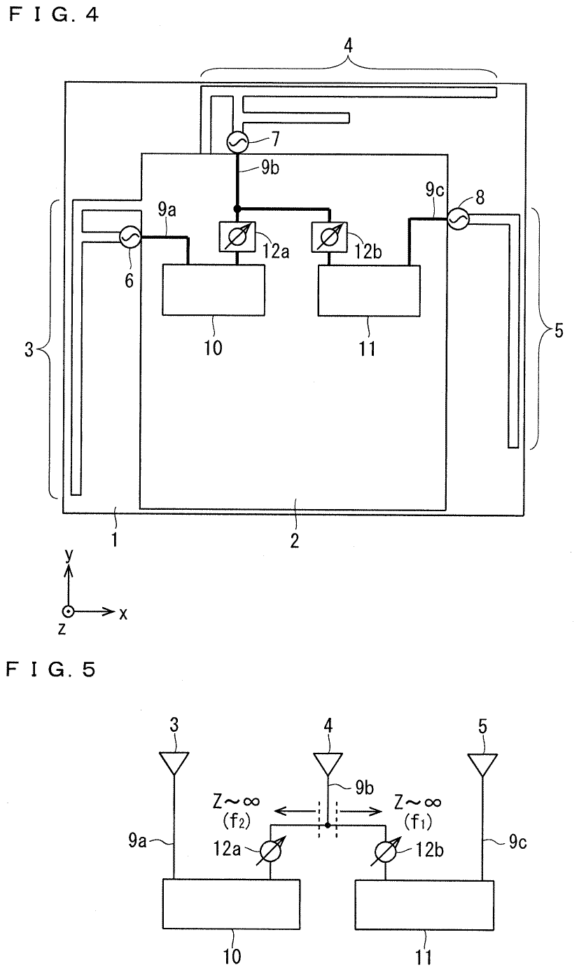

A radio communication apparatus according to Embodiment 2 will be described with reference to FIGS. 4 to 8. Since in FIGS. 4 to 8, the same reference numerals are assigned to the same or corresponding elements described in Embodiment 1, the overlapping description will be omitted.

FIG. 4 is a diagram illustrating a structure of the radio communication apparatus according to Embodiment 2. The structure of the dielectric substrate 1, the ground conductor 2, the first antenna 3, the second antenna 4, and the third antenna 5 is identical to FIG. 1.

As illustrated in FIG. 4, the second antenna 4 is connected to a transmission line 9b on the dielectric substrate 1. The transmission line 9b branches into two paths at some midpoint, and the two paths are connected to a first transmission/reception module 10 and a second transmission/reception module 11. A phase shifter 12a that can adjust a phase is inserted between a branch point of the transmission line 9b and the first transmission/reception module 10, and a phase shifter 12b that can adjust a phase is inserted between the branch point of the transmission line 9b and the second transmission/reception module 11. The first transmission/reception module 10 corresponds to the frequency f₁, and the second transmission/reception module 11 corresponds to the frequency f₂. The first transmission/reception module 10 and the second transmission/reception module 11 have a function of converting information to be transmitted into a high frequency signal and a function of retrieving information received from a high frequency signal.

Furthermore, the first antenna 3 is connected to the first transmission/reception module 10 through a transmission line 9a. The third antenna 5 is connected to the second transmission/reception module 11 through a transmission line 9c.

FIG. 5 is a diagram illustrating a circuit structure of the radio communication apparatus according to Embodiment 2.

The second antenna 4 supports two frequencies (f₁ and f₂). Thus, when the transmission line 9b is directly connected to the first transmission/reception module 10 and the second transmission/reception module 11, there is apprehension that reflectance properties may significantly deteriorate depending on a reflection phase of impedance of the first transmission/reception module 10 viewed from the branch point of the transmission line 9b or a reflection phase of impedance of the second transmission/reception module 11 viewed from the branch point of the transmission line 9b. These reflection phases are preferably closer to zero.

In Embodiment 2, the phase shifter 12a is inserted between the branch point of the transmission line 9b and the first transmission/reception module 10, and an amount of phase shift of the phase shifter 12a is determined such that the reflection phase of impedance of the first transmission/reception module 10 viewed from the branch point of the transmission line 9b becomes zero at the operating frequency f₂. This makes the impedance of the first transmission/reception module 10 viewed from the branch point of the transmission line 9b electrically open at the frequency f₂, and can eliminate the reflection from the first transmission/reception module 10.

Furthermore, the phase shifter 12b is inserted between the branch point of the transmission line 9b and the second transmission/reception module 11, and an amount of phase shift of the phase shifter 12b is determined such that the reflection phase of impedance of the second transmission/reception module 11 viewed from the branch point of the transmission line 9b becomes zero at the operating frequency f₁. This makes the impedance of the second transmission/reception module 11 viewed from the branch point of the transmission line 9b electrically open at the frequency f₁, and can eliminate the reflection from the second transmission/reception module 11.

The phase shifters 12a and 12b may be distributed constant lines or lumped constant elements such as chip components.

As described above, determining an amount of phase shift of a phase shifter such that the impedance of a transmission/reception module (the first transmission/reception module 10 or the second transmission/reception module 11) viewed from the branch point of the transmission line 9b connected to the second antenna 4 for supporting multiple bands looks open outside a band produces advantages similar to those of a diplexer that isolates a frequency.

In the radio communication apparatus according to Embodiment 2, the first transmission/reception module 10 and the second transmission/reception module 11 can share antennas with low losses by constructing a simple circuit that can demultiplex a signal into two frequencies (f₁ and f₂) on the dielectric substrate 1, without using a component such as a diplexer that isolates a frequency.

### [Modification 1]

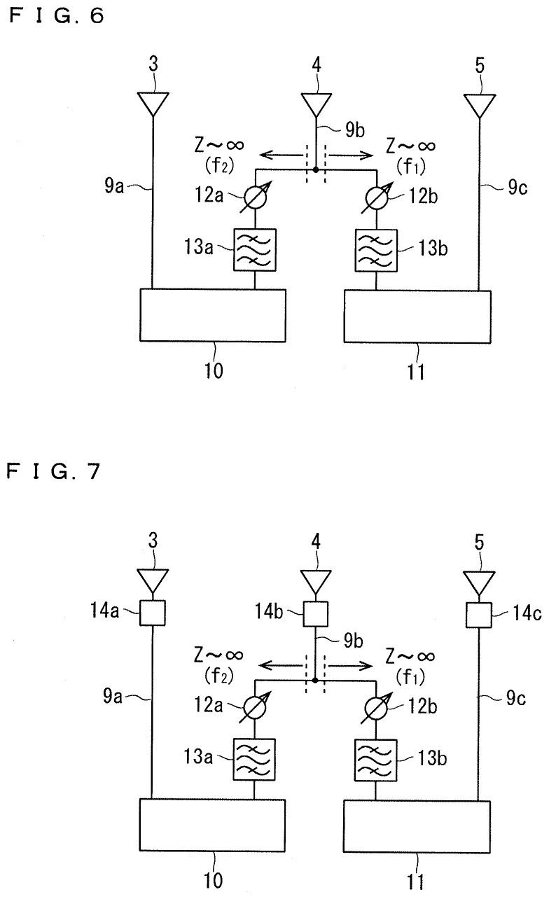

FIG. 6 is a diagram illustrating a circuit structure according to Modification 1 of the radio communication apparatus of Embodiment 2.

A structure of FIG. 6 is obtained by inserting a bandpass filter 13a between the phase shifter 12a and the first transmission/reception module 10 and inserting a bandpass filter 13b between the phase shifter 12b and the second transmission/reception module 11 in the structure of FIG. 5.

Modification 1 can increase a reflection amplitude of the phase shifter 12a side viewed from the branch point of the transmission line 9b at the frequency f₂ and a reflection amplitude of the phase shifter 12b side viewed from the branch point of the transmission line 9b at the frequency f₁, and reduce the influence of out-of-band reflected waves more.

### [Modification 2]

FIG. 7 is a diagram illustrating a circuit structure according to Modification 2 of the radio communication apparatus Embodiment 2.

A structure of FIG. 7 is obtained by inserting a matching circuit 14a at a root (a connection portion to the first antenna 3) of the transmission line 9a to be connected to the first antenna 3, inserting a matching circuit 14b at a root (a connection portion to the second antenna 4) of the transmission line 9b to be connected to the second antenna 4, and inserting a matching circuit 14c at a root (a connection portion to the third antenna 5) of the transmission line 9c to be connected to the third antenna 5 in the structure of FIG. 6.

The matching circuits 14a, 14b, and 14c according to Modification 2 can implement impedance matching. The matching circuits 14a, 14b, and 14c may be distributed constant lines or lumped constant elements such as chip components.

### [Modification 3]

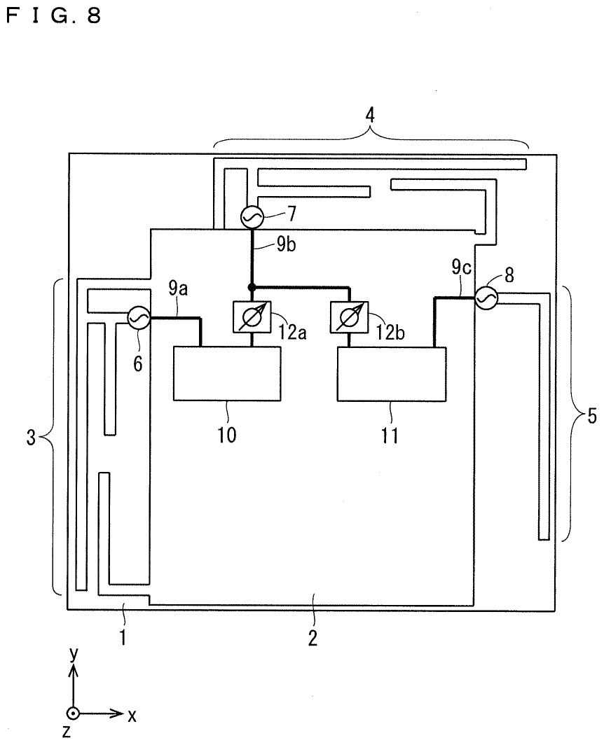

In Modification 3, the antenna circuit of Embodiment 2 is applied to the radio communication apparatus in FIG. 3 which supports the three operating frequencies (f₁, f₂, and f₃). FIG. 8 is a diagram illustrating Modification 3 of the radio communication apparatus according to of Embodiment 2.

Even when the number of operating frequencies of the radio communication apparatus is three, a structure of the antenna circuit similar to FIG. 3 can be employed. The first transmission/reception module 10 in FIG. 8 needs to support two frequencies of f₁ and f₃. Determining the amount of phase shift of the phase shifter 12b such that the reflection phase of impedance of the second transmission/reception module 11 viewed from the branch point of the transmission line 9b becomes zero at each of the frequencies of f₁ and f₃ can eliminate reflection from the second transmission/reception module 11.

### Embodiment 3

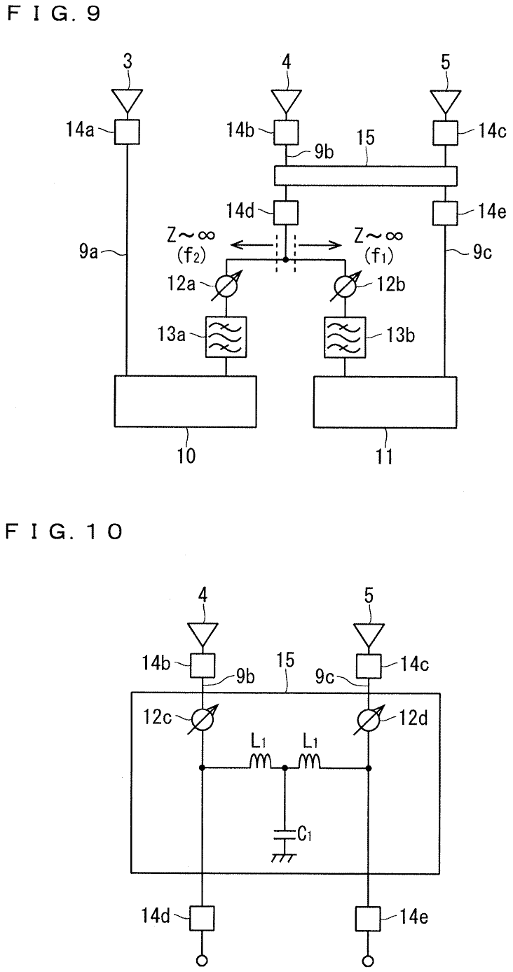

FIG. 9 is a diagram illustrating a structure of a radio communication apparatus according to Embodiment 3. Since in FIG. 9, the same reference numerals are assigned to the same or corresponding elements described in Embodiments 1 and 2, the overlapping description will be omitted.

Since lowering the correlation between the first antenna 3 and the second antenna 4 is difficult because of their operations at the lowest frequency f₁ in the operating frequencies of the radio communication apparatus, the first antenna 3 and the second antenna 4 are arranged in the arrangement of FIG. 2 (a) whose correlation is easily lowered in Embodiment 1. Thus, the second antenna 4 and the third antenna 5 are arranged in the arrangement of FIG. 2 (b). However, lowering the correlation between the second antenna 4 and the third antenna 5 as much as that of the arrangement in FIG. 2 (a) is ideal.

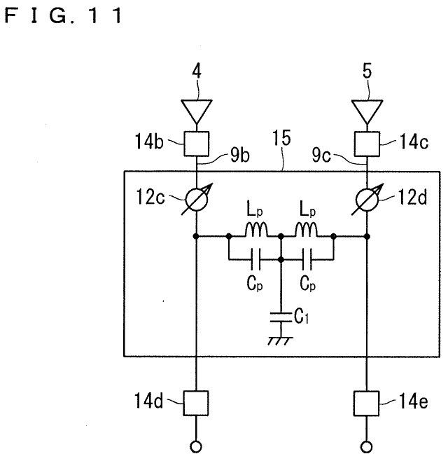

Here, a decoupling circuit 15 that reduces antenna-to-antenna coupling between the second antenna 4 and the third antenna 5 at the frequency f₂ is inserted between the transmission line 9b connected to the second antenna 4 and the transmission line 9c connected to the third antenna 5 to lower a correlation between the second antenna 4 and the third antenna 5 in Embodiment 3. FIGS. 10 and 11 illustrate examples of the decoupling circuit 15.

FIG. 10 illustrates an example of the decoupling circuit 15 with a matching circuit function supporting one frequency. When this decoupling circuit 15 is used, an amount of phase shift of each of phase shifters 12c and 12d is adjusted such that a real part of admittance Y32 of a corresponding one of the second antenna 4 and the third antenna 5 becomes zero at the frequency f₂ supported by the second antenna 4. Furthermore, a value of an inductor Li included in the decoupling circuit 15 is adjusted such that an imaginary part of the admittance Y32 becomes zero at the frequency f₂. Here, a value of a capacitor C₁ can be obtained from the following Equation.

$${C}_{1} = \frac{1}{{{L}_{1} ( 2 π {f}_{2} )}^{2}} \qquad [ Math 1 ]$$

Although application of the decoupling circuit 15 in FIG. 10 to the radio communication apparatus in FIG. 8 can lower the correlation between the second antenna 4 and the third antenna 5 at the frequency f₂, the impedance matching significantly deteriorates at the frequency f₃ far from the frequency f₂.

The radio communication apparatus in FIG. 8 needs the decoupling circuit 15 supporting two frequencies. FIG. 11 is a diagram illustrating an example decoupling circuit with a matching circuit function supporting two frequencies using a parallel resonance circuit.

In the decoupling circuit 15 of FIG. 11, values of an inductor Lₚ and a capacitor Cₚ of the parallel resonance circuit are determined such that the decoupling circuit 15 looks like the inductor Li at the frequency f₂ and the decoupling circuit 15 looks electrically open at the frequency f₃. Here, the values of the inductor Lₚ and the capacitor Cₚ can be obtained from the following Equations.

$${L}_{p} = \frac{\frac{{f}_{2}}{{f}_{3}} - \frac{{f}_{3}}{{f}_{2}}}{2 π {f}_{3} {B}_{1}} \qquad [ Math 2 ]$$

$${C}_{p} = \frac{{B}_{1}}{2 π {f}_{3} ( \frac{{f}_{2}}{{f}_{3}} - \frac{{f}_{3}}{{f}_{2}} )} \qquad [ Math 3 ]$$

$${B}_{1} = - \frac{1}{{L}_{1} 2 π {f}_{2}} \qquad [ Math 4 ]$$

The decoupling circuit 15 in FIG. 11 can keep impedance matching of the second antenna 4 at the frequency f₃ while lowering the correlation between the second antenna 4 and the third antenna 5 at the frequency f₂.

Furthermore, providing a matching circuit 14d and a matching circuit 14e at subsequent stages of the decoupling circuit 15 (closer to the first transmission/reception module 10 or the second transmission/reception module 11) as illustrated in FIG. 9 can adjust a slight mismatch in impedance matching if such occurs.

The phase shifters 12c and 12d may be distributed constant lines or lumped constant elements such as chip components. The decoupling circuit 15 may be a distributed constant line or a lumped constant element such as a chip component.

While Embodiment 3 exemplifies providing the decoupling circuit 15 to couple the second antenna 4 to the third antenna 5, the decoupling circuit 15 may be provided to couple the first antenna 3 to the second antenna 4.

Embodiment 4 can implement a diversity antenna with low correlation while maintaining the size of a radio communication apparatus smaller by inserting the decoupling circuit 15 including inductors and a capacitor between the antennas to reduce the coupling between the antennas and lower the correlation.

### Embodiment 4

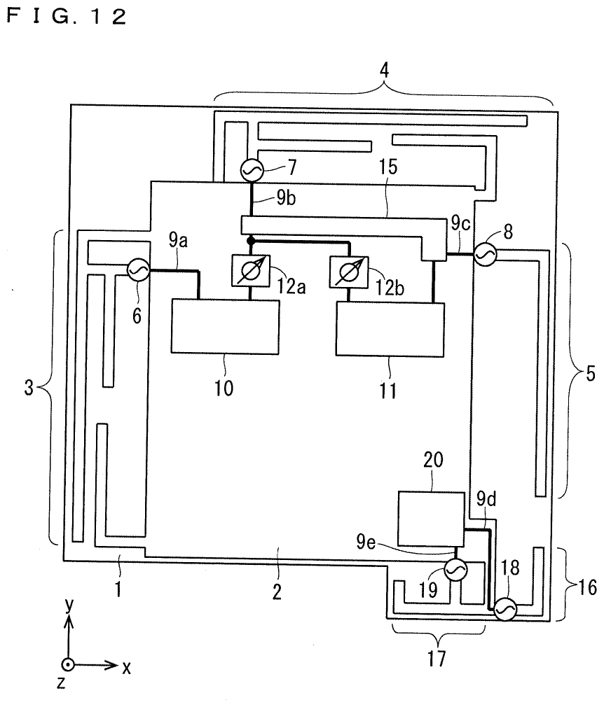

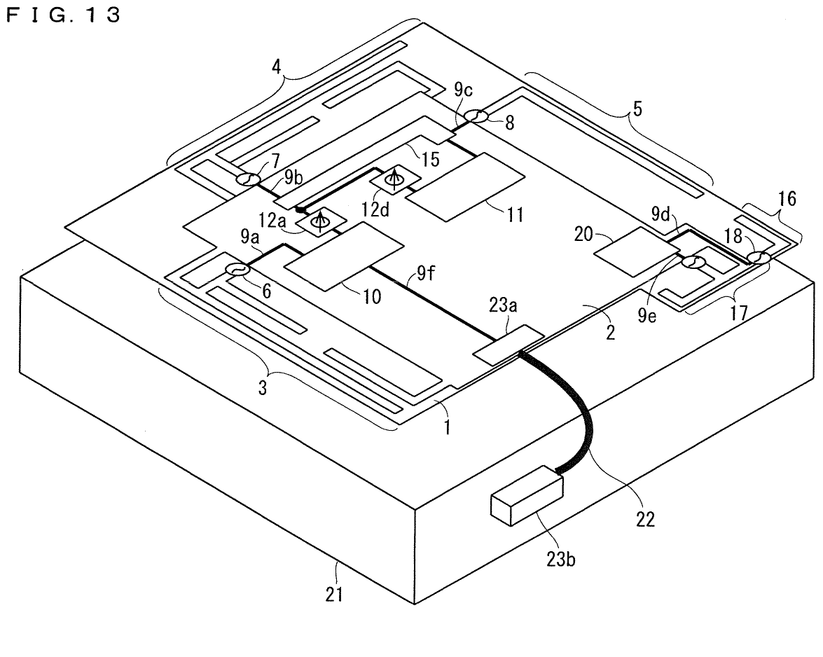

FIG. 12 is a diagram illustrating a structure of a radio communication apparatus according to Embodiment 4. Since in FIG. 12, the same reference numerals are assigned to the same or corresponding elements described in Embodiments 1 to 3, the overlapping description will be omitted.

The radio communication apparatus in FIG. 12 is obtained by adding, to the structure of FIG. 8, a fourth antenna 16 and its feeding point 18, a fifth antenna 17 and its feeding point 19, and a third transmission/reception module 20.

The fourth antenna 16 and the fifth antenna 17 are formed on the dielectric substrate 1, and are disposed at diagonal positions as seen from a corner between the first side of the dielectric substrate 1 along which the first antenna 3 is disposed and the second side of the dielectric substrate 1 along which the second antenna 4 is disposed. The fourth antenna 16 is disposed along the third side along which the third antenna 5 is disposed, and the fifth antenna 17 is disposed along a fourth side facing the second side.

While each of the fourth antenna 16 and the fifth antenna 17 is formed by etching a metal film deposited on the dielectric substrate 1 in Embodiment 4, they may be formed using, for example, a sheet metal or a metal wire.

The feeding point 18 of the fourth antenna 16 is disposed between the fourth antenna 16 and the ground conductor 2. The feeding point 19 of the fifth antenna 17 is disposed between the fifth antenna 17 and the ground conductor 2. Each of the feeding points 18 and 19 is a portion that drives a high frequency signal.

Operating frequencies of the fourth antenna 16 and the fifth antenna 17 are both a frequency f₄. The third transmission/reception module 20 supports the operating frequency f₄ of the fourth antenna 16 and the fifth antenna 17. The fourth antenna 16 is connected to the third transmission/reception module 20 through a transmission line 9d, and the fifth antenna 17 is connected to the third transmission/reception module 20 through a transmission line 9e.

The shape of the fourth antenna 16 will be specifically described. Specifically, the fourth antenna 16 extends in +x direction from the feeding point 18, is bent at some midpoint, and extends in +y direction from the bend point along the third side of the dielectric substrate 1. This allows the fourth antenna 16 to function as an inverted-L antenna. The fourth antenna 16 may include a short circuit portion, similarly to the first antenna 3 and the second antenna 4.

The shape of the fifth antenna 17 will be specifically described. The fifth antenna 17 is disposed along the fourth side of the dielectric substrate 1 such that the fifth antenna 17 is orthogonal to the fourth antenna 16. The fifth antenna 17 extends from the branch point 19 in −y direction, and branches into two paths at some midpoint. One of the branching portions of the fifth antenna 17 extends in −x direction along the fourth side, and the other portion extends in +x direction and then is shorted to the ground conductor 2. This allows the fifth antenna 17 to operate as an inverted-F antenna, and facilitates the impedance matching. The fifth antenna 17 need not always include a short circuit portion.

In FIG. 12, a protruding region obtained by protruding a part of the substantially square dielectric substrate 1 is provided, and the fourth antenna 16 and the fifth antenna 17 are disposed in the protruding portion. The protruding region, however, need not always be provided in the dielectric substrate 1. In other words, the fourth antenna 16 and the fifth antenna 17 may be disposed in a part of a region of the dielectric substrate 1 while the dielectric substrate 1 maintains the substantially square shape.

The fourth antenna 16 and the fifth antenna 17 each have an overall length equal to a length of ¼ of a wavelength corresponding to the operating frequency f₄. In other words, a length of each of the fourth antenna 16 and the fifth antenna 17 from the base end of the vertical portion to an open end of the horizontal portion through a folding point is the length of ¼ of the wavelength corresponding to the operating frequency f₄.

The fourth antenna 16 and the fifth antenna 17 are arranged in the arrangement of FIG. 2 (a). This makes the correlation between the fourth antenna 16 and the fifth antenna 17 lower, and the fourth antenna 16 and the fifth antenna 17 operate as a diversity antenna at the frequency f₄.

While the operating frequencies f₁, f₂, f₃, and f₄ may be any frequencies, the operating frequencies f₁, f₂, f₃, and f₄ preferably satisfy a relationship of f₁<f₂<f₃<f₄. While the fourth antenna 16 and the fifth antenna 17 are disposed at positions closer to each other, increasing the operating frequency f₄ of the fourth antenna 16 and the fifth antenna 17 can ensure an electrical distance between fourth antenna 16 and the fifth antenna 17 and lower a correlation between the fourth antenna 16 and the fifth antenna 17.

The fourth antenna 16 and the fifth antenna 17 are disposed at diagonal positions as seen from the corner between the first side of the dielectric substrate 1 along which the first antenna 3 is disposed and the second side of the dielectric substrate 1 along which the second antenna 4 is disposed. In other words, the fourth antenna 16 and the fifth antenna 17 are disposed away from the first antenna 3 and the second antenna 4. A correlation between antennas tends to increase as the operating frequencies are closer. When the relationship of f₁<f₂<f₃<f₄ is satisfied, a distance between the fourth antenna 16 and the fifth antenna 17 whose operating frequency is the frequency f₄ and the first antenna 3 and the second antenna 4 whose operating frequency is the frequency f₃ that is relatively closer to the frequency f₄ can be ensured, and a correlation between the first antenna 3 and the second antenna 4 and the fourth antenna 16 and the fifth antenna 17 can be lowered.

As described above, the radio communication apparatus according to Embodiment 4 can create diversity corresponding to four frequencies (f₁, f₂, f₃, and f₄) using five antennas with low correlations, and obtains high communication quality.

### Embodiment 5

FIG. 13 is a diagram illustrating a structure of a measurement system with a radio communication function according to Embodiment 5. Since in FIG. 13, the same reference numerals are assigned to the same or corresponding elements described in Embodiments 1 to 4, the overlapping description will be omitted.

The measurement system according to Embodiment 5 is a sensor system with the radio communication function that is provided in a sensor network. As illustrated in FIG. 13, the measurement system includes the radio communication apparatus in FIG. 12, a measurement unit 21, and a connection cable 22 electrically connecting the radio communication apparatus to the measurement unit 21. The radio communication apparatus included in the measurement system is not limited to the radio communication apparatus in FIG. 13 but may be the radio communication apparatus illustrated in, for example, FIG. 3, 4, or 8.

The measurement unit 21 measures data using a sensor, and transmits the measured data to an external via radio waves radiated from the radio communication apparatus. As illustrated in FIG. 13, the measurement unit 21 is disposed in close proximity to a lower portion of the dielectric substrate 1 of the radio communication apparatus. Conversely speaking, the radio communication apparatus is overlaid on the measurement unit 21.

The connection cable 22 includes a connector 23a for connecting to the radio communication apparatus at one end, and a connector 23b for connecting to the measurement unit 21 at the other end. The connector 23a of the connection cable 22 is connected to the ground conductor 2 on the fourth side of the dielectric substrate 1 (the lower side of the dielectric substrate 1 in FIG. 12). The connector 23a is connected to the first transmission/reception module 10 through a transmission line 9f. The connector 23a may be connected to the second transmission/reception module 11 or the third transmission/reception module 20. Furthermore, a signal entering the dielectric substrate 1 from the connector 23a may be shared between the first transmission/reception module 10, the second transmission/reception module 11, and the third transmission/reception module 20 through a dedicated communication line.

Data measured by the measurement unit 21 is transmitted to the radio communication apparatus through the connection cable 22, and is transmitted to a communication partner via radio waves radiated from the radio communication apparatus. The measurement unit 21 may transmit not only the measured data but also, for example, an ID of the measurement unit 21 or information on a measurement time of the sensor data to the communication partner through the radio communication apparatus.

When a high frequency signal flows through the surface of the connection cable 22 formed of a conductor, the connection cable 22 operates like an antenna to radiate unnecessary radio waves, which may affect antenna characteristics of the radio communication apparatus. Thus, it is preferred not to dispose the connection cable 22 in the vicinity of an antenna and a feeding point on which a current concentrates. The measurement system according to Embodiment 5 prevents the connection cable 22 from being disposed in the vicinity of an antenna and a feeding point by mounting the connector 23a of the connection cable 22 in the space of the fourth side of the dielectric substrate 1 in which no antenna is disposed. This prevents a decrease in the efficiency of antennas, and implements the measurement system with the radio communication function including a diversity antenna with high efficiency.

Embodiments of the present disclosure can be freely combined, and appropriately modified or omitted.

The foregoing description is in all aspects illustrative, and numerous modifications that have yet been exemplified will be devised.

### EXPLANATION OF REFERENCE SIGNS

1 dielectric substrate, 2 ground conductor, 3 first antenna, 4 second antenna, 5 third antenna, 6 to 8, 18, 19 feeding point, 9a to 9f transmission line, 10 first transmission/reception module, 11 second transmission/reception module, 12a to 12d phase shifter, 13a, 13b bandpass filter, 14a to 14e matching circuit, 15 decoupling circuit, 16 fourth antenna, 17 fifth antenna, 20 third transmission/reception module, 21 measurement unit, 22 connection cable, 23a, 23b connector.

1. A radio communication apparatus, comprising:
a dielectric substrate;
a ground conductor disposed on the dielectric substrate;
a first antenna disposed on the dielectric substrate along a first side of the dielectric substrate;
a second antenna disposed on the dielectric substrate along a second side adjacent to the first side of the dielectric substrate; and
a third antenna disposed on the dielectric substrate along a third side facing the first side of the dielectric substrate;
wherein an open end of the first antenna is directed in a direction away from the second side,
an open end of the second antenna is directed in a direction away from the first side,
an open end of the third antenna is directed in a direction away from the second side,
the first antenna supports a first frequency,
the third antenna supports a second frequency, and
the second antenna supports the first frequency and the second frequency.

2. (canceled)

3. The radio communication apparatus according to claim 1,
wherein assuming that f₁ denotes the first frequency and f₂ denotes the second frequency, a relationship of f₁<f₂ is satisfied.

4. The radio communication apparatus according to claim 1,
wherein the second antenna is connected to a transmission line disposed on the ground conductor, and
the transmission line includes a branch point branching into a line connected to a first transmission/reception module supporting the first frequency, and a line connected to a second transmission/reception module supporting the second frequency,
the radio communication apparatus comprising:
a first phase shifter disposed between the branch point and the first transmission/reception module, the first phase shifter being capable of adjusting a phase; and
a second phase shifter disposed between the branch point and the second transmission/reception module, the second phase shifter being capable of adjusting a phase.

5. The radio communication apparatus according to claim 1,
wherein the first antenna supports a first frequency and a third frequency,
the third antenna supports a second frequency, and
the second antenna supports the first frequency, the second frequency, and the third frequency.

6. The radio communication apparatus according to claim 5,
wherein assuming that f₁ denotes the first frequency, f₂ denotes the second frequency, and f₃ denotes the third frequency, a relationship of f₁<f₂<f₃ is satisfied.

7. The radio communication apparatus according to claim 5,
wherein the second antenna is connected to a transmission line disposed on the ground conductor, and
the transmission line includes a branch point branching into a line connected to a first transmission/reception module supporting the first frequency and the third frequency, and a line connected to a second transmission/reception module supporting the second frequency,
the radio communication apparatus comprising:
a first phase shifter disposed between the branch point and the first transmission/reception module, the first phase shifter being capable of adjusting a phase; and
a second phase shifter disposed between the branch point and the second transmission/reception module, the second phase shifter being capable of adjusting a phase.

8. A radio communication apparatus, comprising:
a dielectric substrate;
a ground conductor disposed on the dielectric substrate;
a first antenna disposed on the dielectric substrate along a first side of the dielectric substrate;
a second antenna disposed on the dielectric substrate along a second side adjacent to the first side of the dielectric substrate;
a third antenna disposed on the dielectric substrate along a third side facing the first side of the dielectric substrate;
a fourth antenna disposed along the third side and disposed at a diagonal position as seen from a corner between the first side and the second side of the dielectric substrate; and
a fifth antenna disposed along a fourth side facing the second side of the dielectric substrate and disposed at a diagonal position as seen from the corner between the first side and the second side of the dielectric substrate,
wherein the first antenna supports a first frequency,
the third antenna supports a second frequency,
the second antenna supports the first frequency and the second frequency,
both of the fourth antenna and the fifth antenna support a fourth frequency, and
assuming that f₁ denotes the first frequency, f₂ denotes the second frequency, and f₄ denotes the fourth frequency, a relationship of f₁<f₂<f₄ is satisfied.

9. (canceled)

10. The radio communication apparatus according to claim 1, comprising
a decoupling circuit connected between the second antenna and the third antenna to lower a correlation between the second antenna and the third antenna at the second frequency.

11. A measurement system with a radio communication function, comprising:
the radio communication apparatus according to claim 1;
a measurement unit to measure, using a sensor, data to be transmitted to an external via radio waves radiated from the radio communication apparatus; and
a connection cable connecting the radio communication apparatus to the measurement unit,
wherein the radio communication apparatus is overlaid on the measurement unit, and
an end of the connection cable is connected to the measurement unit, and an other end of the connection cable is connected to the ground conductor of the radio communication apparatus.

12. A measurement system with a radio communication function, comprising:
the radio communication apparatus according to claim 8;
a measurement unit to measure, using a sensor, data to be transmitted to an external via radio waves radiated from the radio communication apparatus; and
a connection cable connecting the radio communication apparatus to the measurement unit,
wherein the radio communication apparatus is overlaid on the measurement unit, and
an end of the connection cable is connected to the measurement unit, and an other end of the connection cable is connected to the ground conductor of the radio communication apparatus.

13. The radio communication apparatus according to claim 8,
wherein the first antenna supports a first frequency and a third frequency,
the second antenna supports the first frequency, the second frequency, and the third frequency, and
assuming that f₃ denotes the third frequency, a relationship of f₁<f₂<f₃<f₄ is satisfied.
